(19) United States
(12) Patent Application Publication
(10) Pub. No.: US 2012/0229427 A1
(43) Pub. Date: Sep. 13, 2012

(54) STYLUS

(75) Inventor: QIN LI, Shenzhen City (CN)

(73) Assignees: FIH (HONG KONG) LIMITED, Kowloon (HK); SHENZHEN FUTAIHONG PRECISION INDUSTRY CO., LTD., ShenZhen City (CN)

(21) Appl. No.: 13/271,374

(22) Filed: Oct. 12, 2011

(30) Foreign Application Priority Data
Mar. 7, 2011 (CN) 201110053123.8

(51) Int. Cl. G06F 3/033

(52) U.S. Cl. 345/179

(57) ABSTRACT

A stylus includes a stylus body, a stylus body and a rotation mechanism. The stylus body includes a first housing and a second housing. The stylus body defines an hole. The rotation mechanism includes two resilient elements respectively retained to the first housing and the second housing, and a shaft. Each resilient element defines an hole and a plurality of holes. A center portion of the shaft is rotatably retained in the hole, and two ends of the shaft are respectively retained in the holes. When the stylus body rotates about the shaft relative to the first housing and the second housing, the shaft is capable of making the resilient elements bend to provide a good pressing feel.

### BACKGROUND

1. Technical Field

This exemplary disclosure generally relates to styluses.

2. Description of Related Art

Touch screens are included in a variety of electronic devices. Some of these devices include smart phones, personal digital assistants (PDA), pagers, and personal organizers, for example. These devices typically include a display module under the touch screen. The display module generates target images associated with menu options, programs, user choices, and other operations. The user controls the device by pressing a stylus on the touch screen over the target image. However, stylus bodies of typical styluses cannot rotate relative to housings and thereof can be convenient to use.

Therefore, there is room for improvement within the art

### BRIEF DESCRIPTION OF THE DRAWINGS

Many aspects of the exemplary stylus can be better understood with reference to the following drawings. The components in the various drawings are not necessarily drawn to scale, the emphasis instead being placed upon clearly illustrating the principles of the exemplary stylus. Moreover, in the drawings, like reference numerals designate corresponding parts throughout the diagrams.

FIG. 1 is an exploded view of an exemplary stylus.

FIG. 2 is another exploded view of the stylus of FIG. 2 viewed from another aspect.

FIG. 3 is an assembled view of the stylus shown in FIG. 1 in a retracted state.

FIG. 4 is similar to FIG. 3, but wherein a second housing is removed.

FIG. 5 is similar to FIG. 4, but wherein the stylus is in a first tilted state.

FIG. 6 is similar to FIG. 4, but wherein the stylus is in a second tilted state.

### DETAILED DESCRIPTION

In this exemplary embodiment, the stylus is used to contact a touch screen display of an electronic device such as a mobile telephone. The mobile telephone described herein is a representation of the type of wireless communication device that may benefit from the exemplary embodiment. However, it is to be understood that the exemplary embodiment may be applied to any type of hand-held or portable device including, but not limited to, the following devices: radiotelephones, cordless phones, paging devices, personal digital assistants, portable computers, pen-based or keyboard-based handheld devices, remote control units, portable media players (such as an MP3 or DVD player) that have wireless communication capability and the like. Accordingly, any reference herein to the mobile telephone should also be considered to apply equally to other portable wireless electronic devices.

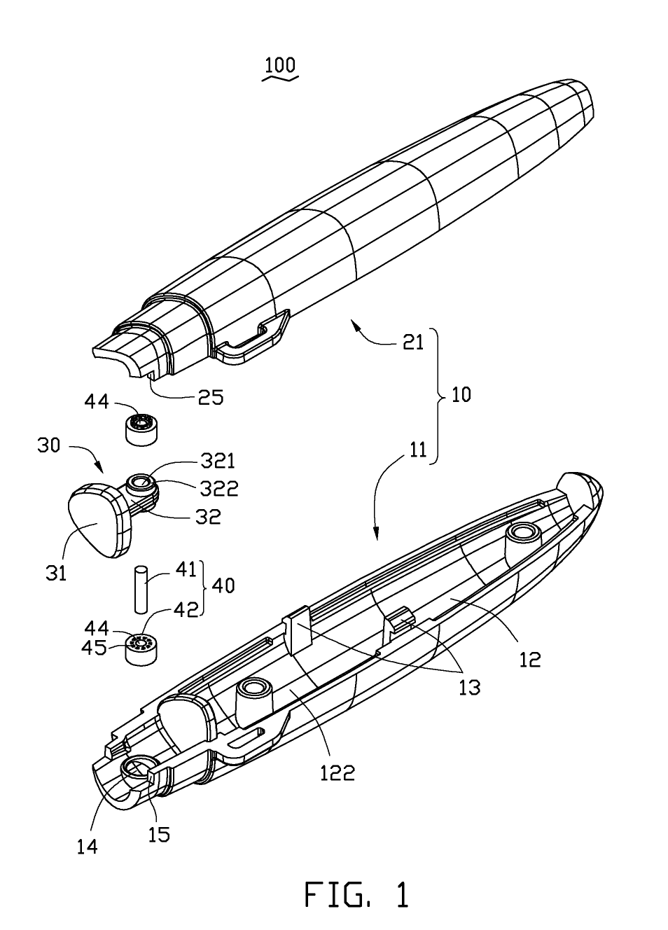

Referring to FIG. 1, a stylus 100 includes a stylus body 10, a stylus tip body 30, and a rotation mechanism 40 rotatably retaining the stylus tip body 30 to the stylus body 10. The stylus body 10 includes a first housing 11 and a second housing 21.

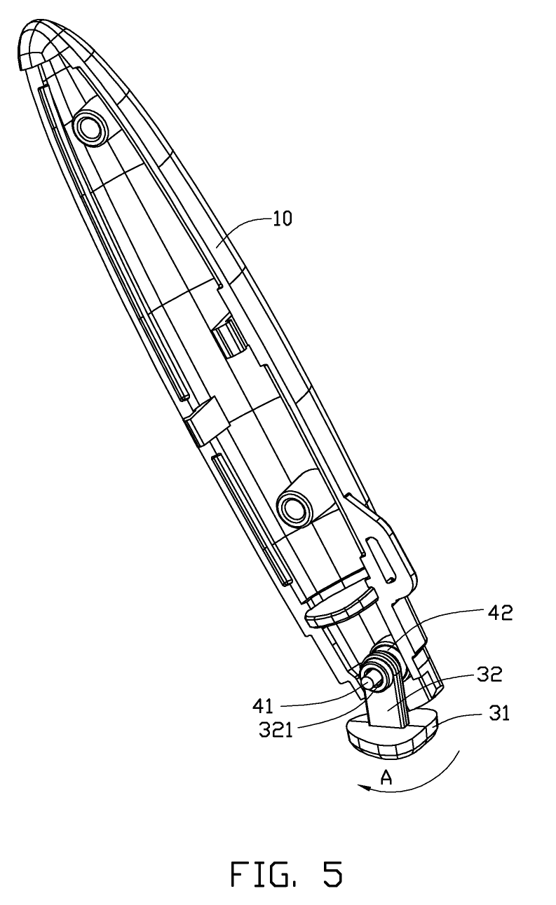

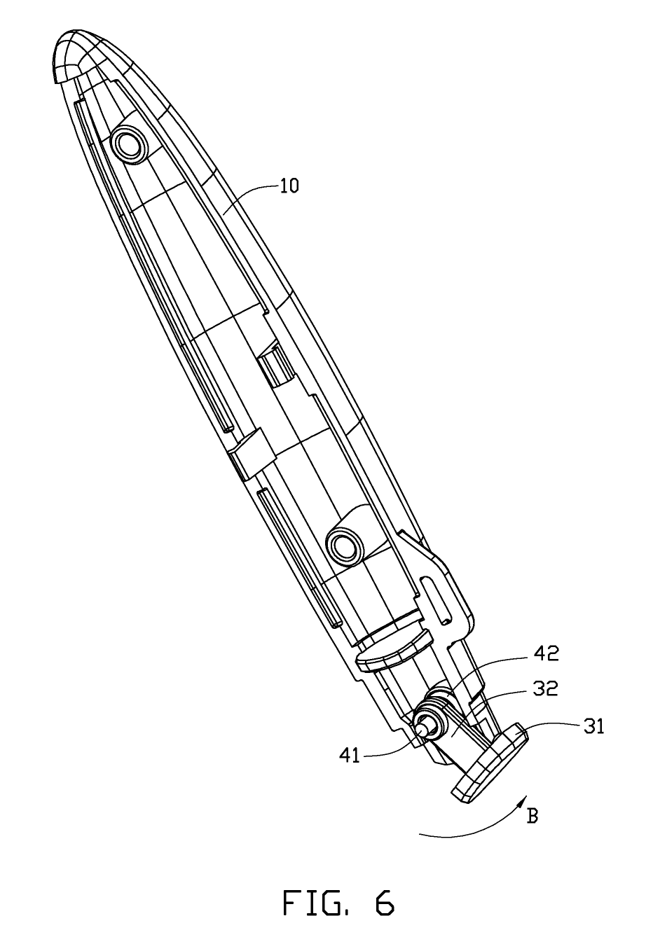

The first housing 11 is substantially semi-circular and longitudinally defines a first space 12. The first housing 11 has a first inner surface 122. The first housing 11 includes two hooks 13 protruding from the first inner surface 122. The hooks 13 are for latching with the second housing 21 so the first housing 11 and the second housing 21 are assembled together. The first housing 11 further defines a first mounting hole 14 in the first inner surface 122 located near one end of the first housing 11. The first mounting hole 14 is for mating with the rotation mechanism 40, as will be described in detail below. The first housing 11 may further include two first stopping walls 15 respectively located adjacent opposite sides of the first mounting hole 14. Referring to FIGS. 5 and 6, the first stopping walls 15 selectively resist the stylus tip body 30 to hold the stylus tip body 30 in a first tilted state shown in FIG. 5 and a second tilted state shown in FIG. 6.

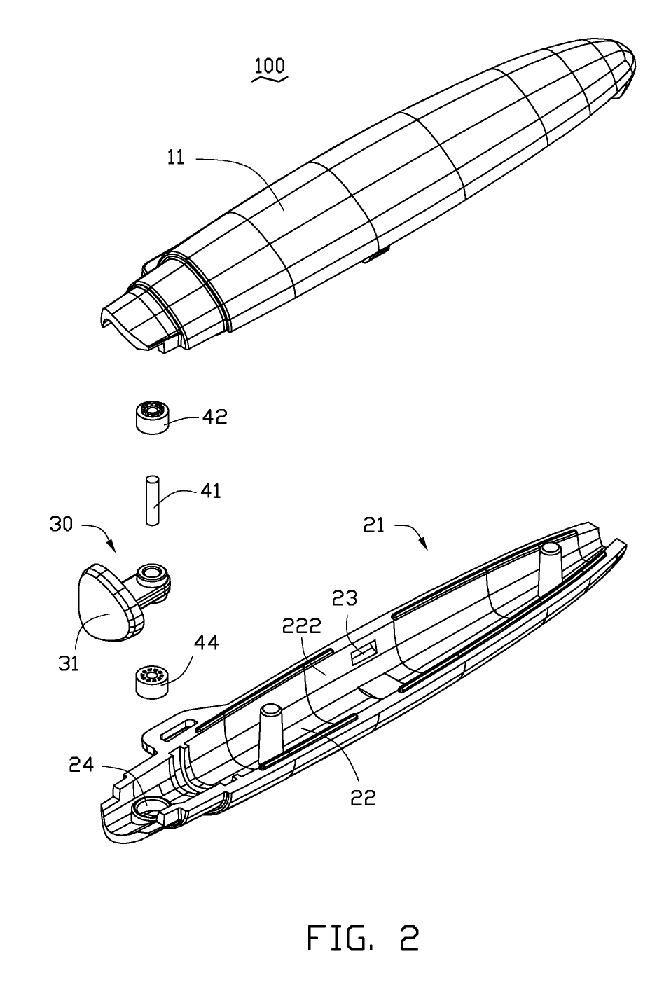

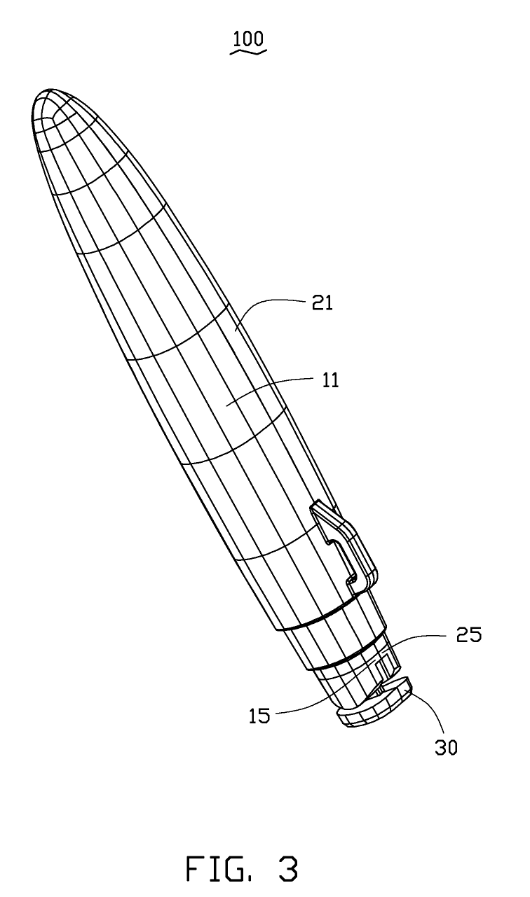

Referring to FIG. 2, the second housing 21 is substantially semi-circular and longitudinally defines a second space 22. The second housing 21 has a second inner surface 222. The second housing 21 defines two latching holes 23 in the second inner surface 222 for corresponding with the hooks 13. Each latching hole 23 latches with one of the hooks 13 to latch the second housing 21 to the first housing 11 so the first housing 11 and the second housing 21 form an assembled stylus body 10. The second housing 21 further defines a second mounting hole 24 opposite to the first housing 11 when the second housing 21 is latched to the first housing 11. The second housing 21 may further include two second stopping walls 25 respectively located adjacent opposite sides of the second mounting hole 24. Referring to FIG. 3, each second stopping board 25 is opposite to one of the first stopping walls 15 when the first housing 11 and the second housing 21 are assembled together. The second stopping walls 25 cooperate with the first stopping walls 15 to hold the stylus tip body 30 in the first tilted state shown in FIG. 5 and the second tilted state shown in FIG. 6.

Referring to FIGS. 1, 3 and 4, the stylus tip body 30 includes a main body 32 and a head 31 protruding from the main body 32. The main body 32 defines a hole 321. The main body 32 further includes two flanges 322, each flange 322 is located at one end of the hole 321 and surrounds the hole 321.

The rotation mechanism 40 includes a shaft 41 and two resilient elements 42. The resilient elements 42 are made of rubber. One of the resilient elements 42 is retained in the first mounting hole 14, and the other resilient element is retained in the second mounting hole 24. Each resilient element 42 defines an hole 44. A center portion of the shaft 41 is rotatably retained in the hole 321. The ends of the shaft 41 are respectively retained in the holes 44 so the stylus tip body 30 is rotatably retained between the first housing 11 and the second housing 21, i.e., the stylus tip body 30 is rotatably retained to the stylus body 10 by combination of the shaft 41 and the hole 321. Each flange 322 resists one of the resilient elements 42 to prevent the stylus tip body 30 from waving. Each resilient element 42 further defines a plurality of apertures 45 surrounding corresponding hole 44. The apertures 45 facilitate the deformation of the resilient elements 42.

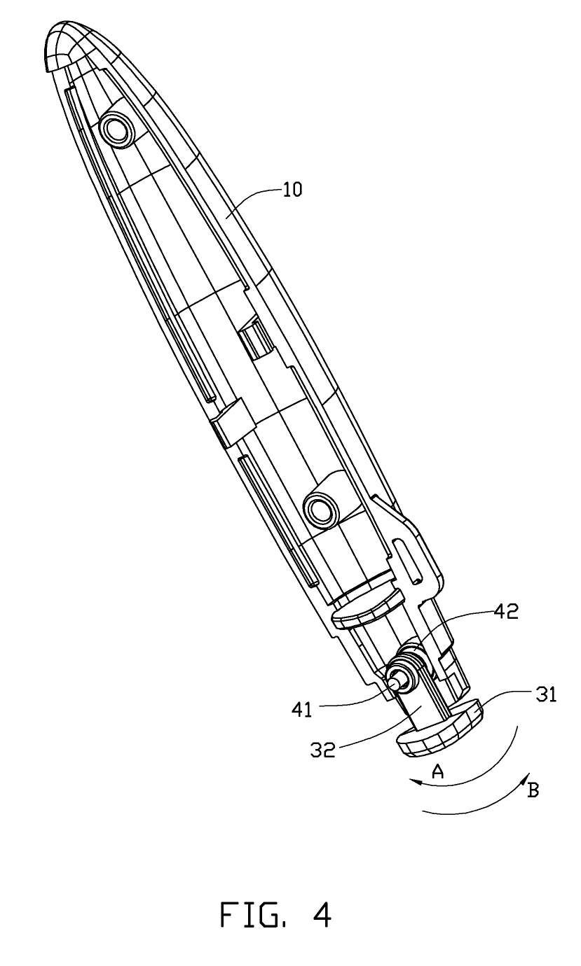

Referring to FIGS. 4-6, in operation, the stylus tip body 30 may rotate about the shaft 41 in a first direction A relative to the stylus body 10. Until the stylus tip body 30 resists the first stopping block 15 and the second stopping block 25 so the stylus tip body 30 is located in the first tilted state shown in FIG. 5 for user convenience. At this time, the stylus tip body 30 can remain in the first tilted state, e.g., by a friction force between the shaft 41 and the stylus tip body 30. Continuing to rotate the stylus tip body 30 in the first direction A, the shaft 41 will press the resilient elements 42 so the resilient elements 42 are elastically deformed to provide a good pressing feel. Additionally, the stylus tip body 30 may rotate about the shaft 41 in a second direction B relative to the stylus body 10. Until the stylus tip body 30 resists the first stopping block 15 and the second stopping block 25, so the stylus tip body 30 is located in the second tilted state shown in FIG. 6 for user convenience. At this time, the stylus tip body 30 can remain in the second tilted state, e.g., by a friction force between the shaft 41 and the stylus tip body 30. Continuing to rotate the stylus tip body 30 in the first direction B, the shaft 41 will press the resilient elements 42 so the resilient elements 42 are elastically deformed to provide a good pressing feel.

It is understood that the two resilient elements 42 may be replaced by other elastic element such as one coil spring coiled around the shaft 41. Two opposite ends of the coil spring respectively retained the first housing 11 and the second housing 21. In addition, the first housing 11 and the second housing 21 may be one integral housing, the shaft 41 may pass through the hole 31, and two ends of the shaft 41 are respectively located at two opposite sides of the integral housing along transverse direction of the housing.

It is to be further understood that even though numerous characteristics and advantages of the exemplary embodiments have been set forth in the foregoing description, together with details of structures and functions of various embodiments, the disclosure is illustrative only, and changes may be made in detail, especially in matters of shape, size, and arrangement of parts within the principles of the exemplary invention to the full extent indicated by the broad general meaning of the terms in which the appended claims are expressed.

What is claimed is:

1. A stylus, comprising:
a stylus body comprising a first housing and a second housing latched to the first housing;
a stylus tip body defining an hole therethrough; and
a rotation mechanism comprising two resilient elements and a shaft, one of the resilient elements retained to the first housing, the other resilient element retained to the second housing, each resilient element defining an hole and a plurality of orifices surrounding the hole;
wherein a center portion of the shaft is rotatably retained in the hole, and two ends of the shaft are respectively retained in the holes so the stylus tip body is rotatably retained between the first housing and the second housing; when the stylus tip body rotates about the shaft relative to the first housing and the second housing, the shaft is capable of making the resilient elements to deform.

2. The stylus as claimed in claim 1, wherein the first housing defines a first mounting hole, the second housing defines a second mounting hole opposite to the first mounting hole; one of the resilient element is retained in the first mounting hole, and the other resilient element is retained in the second mounting hole.

3. The stylus as claimed in claim 2, wherein the stylus tip body comprises a main body and a head protruding from the main body, the hole is defined through the main body.

4. The stylus as claimed in claim 3, wherein the main body further comprises two flanges, each flange is located at one end of the orifice and surrounds the hole; each flange resists one of the resilient elements to prevent the stylus tip body from waving.

5. The stylus as claimed in claim 4, wherein the resilient elements are made of rubber.

6. The stylus as claimed in claim 2, wherein the first housing further comprises two first stopping walls respectively located adjacent opposite sides of the first mounting hole; the first stopping walls selectively resist the stylus tip body to hold the stylus tip body in a first tilted state and a second tilted state.

7. The stylus as claimed in claim 6, wherein the second housing further includes two second stopping walls respectively located adjacent opposite sides of the second mounting hole; each second stopping board is opposite to one of the first stopping walls when the first housing and the second housing are assembled together; the second stopping walls cooperate with the first stopping walls to hold the stylus tip body in the first tilted state and the second tilted state.

8. A stylus, comprising:
a stylus body comprising a first housing and a second housing latched to the second housing;
a stylus tip body defining an hole therethrough; and
a rotation mechanism comprising a shaft, a center portion of the shaft rotatably retained in the hole, and two ends of the shaft respectively retained in the first housing and the second housing so the stylus tip body is rotatably retained between the first housing and the second housing;
wherein the stylus tip body is capable of rotating about the shaft relative to the first housing and the second housing in a first direction until the stylus tip body is located in a first tilted state, and the stylus tip body is capable of rotating about the shaft relative to the first housing and the second housing in a second direction opposite to the first direction until the stylus tip body is located in a second tilted state.

9. The stylus as claimed in claim 8, wherein the stylus tip body remains in the first tilted state and the second tilted state by a friction force between the shaft and the stylus tip body.

10. The stylus as claimed in claim 8, wherein the rotation mechanism further comprises two resilient elements, one of the resilient elements retained to the first housing, the other resilient element retained to the second housing, each resilient element defines an hole; two ends of the shaft are respectively retained in the holes.

11. The stylus as claimed in claim 10, wherein each resilient element further defines a plurality of orifices surrounding corresponding hole; the apertures facilitate making the resilient elements deformed.

12. The stylus as claimed in claim 10, wherein the first housing defines a first mounting hole, the second housing defines a second mounting hole opposite to the first mounting hole; one of the resilient element is retained in the first mounting hole, and the other resilient element is retained in the second mounting hole.

13. The stylus as claimed in claim 12, wherein the stylus tip body comprises a main body and a head protruding from the main body, the hole is defined through the main body.

14. The stylus as claimed in claim 13, wherein the main body further comprises two flanges, each flange is located at one end of the hole and surrounds the hole; each flange resists one of the resilient elements to prevent the stylus tip body from waving.

15. The stylus as claimed in claim 14, wherein the resilient elements are made of rubber.

16. A stylus, comprising:
a stylus body;
a stylus tip body defining an hole therethrough; and
a rotation mechanism comprising at least one resilient element and a shaft, a center portion of the shaft being rotatably retained in the hole and two ends of the shaft respectively retained two opposite sides of the stylus body, and the at least one resilient element resisted between the shaft and the stylus body;
when the stylus tip body rotates about the shaft relative to the stylus body, the shaft is capable of making the resilient elements to deform.

17. The stylus as claimed in claim 16, wherein the stylus body comprises a first housing and a second housing latched to the second housing, one of the resilient elements retained to the first housing, the other resilient element retained to the second housing, the at least one resilient element comprises two resilient element, each resilient element is retained one of the first housing and the second housing.

18. The stylus as claimed in claim 17, wherein the first housing defines a first mounting hole, the second housing defines a second mounting hole opposite to the first mounting hole; one of the resilient element is retained in the first mounting hole, and the other resilient element is retained in the second mounting hole.

19. The stylus as claimed in claim 18, wherein the stylus tip body comprises a main body and a head protruding from the main body, the hole is defined through the main body.

20. The stylus as claimed in claim 18, wherein the first housing further comprises two first stopping walls respectively located adjacent opposite sides of the first mounting hole; the first stopping walls selectively resist the stylus tip body to hold the stylus tip body in a first tilted state and a second tilted state.
